(19) United States
(12) Patent Application Publication
(10) Pub. No.: US 2022/0331955 A1
(43) Pub. Date: Oct. 20, 2022

(54) ROBOTICS CONTROL SYSTEM AND METHOD FOR TRAINING SAID ROBOTICS CONTROL SYSTEM

(71) Applicant: Siemens Aktiengesellschaft, Munich (DE)

(72) Inventors: Eugen Solowjow, Berkeley, CA (US); Juan L. Aparicio Ojea, Moraga, CA (US); Avinash Kumar, Nürnberg (DE); Matthias Loskyll, Neumarkt (DE)

(21) Appl. No.: 17/760,970

(22) PCT Filed: Sep. 30, 2019
(86) PCT No.: PCT/US2019/053839

§ 371 Date: Mar. 16, 2022

(51) Int. Cl. B25J 9/16

(52) U.S. Cl. CPC B25J 9/163; B25J 9/1602; G05B 2219/40499

(57) ABSTRACT

Robotics control system (10) and method for training said robotics control system are provided. Disclosed embodiments make a gracefully blended utilization of Reinforcement Learning (RL) with conventional control by way of a dynamically adaptive interaction between respective control signals (20, 24) generated by a conventional feedback controller (18) and an RL controller (22). Additionally, disclosed embodiments make use of an iterative approach for training a control policy by effective use of virtual sensor and actuator data (60) interleaved with real-world sensor and actuator data (54). This is effective to reducing a training sample size to fulfill a blended control policy for the conventional feedback controller and the reinforcement learning controller. Disclosed embodiments may be used in a variety of industrial automation applications.

### BACKGROUND

### 1. Field

Disclosed embodiments relate generally to the field of industrial automation and control, and, more particularly, to control techniques involving an adaptively weighted combination of reinforcement learning and conventional feedback control techniques, and, even, more particularly, to robotics control system and method suitable for industrial reinforcement learning.

### 2. Description of the Related Art

Conventional feedback control techniques (which may be referred throughout this disclosure as “conventional control”) can solve various types of control problems—such as without limitation, robotics control, autonomous industrial automation, etc.—This conventional control is generally accomplished by very efficiently capturing an underlying physical structure with explicit models. In one example application, this could involve an explicit definition of the body equations of motion that may be involved for controlling a trajectory of a given robot. It will be appreciated, however, that many control problems in modern manufacturing can involve various physical interactions with objects, such as may involve, without limitation, contacts, impacts, and/or friction with one or more of the objects. These physical interactions tend to be more difficult to capture with a first-order physical model. Hence, applying conventional control techniques to these situations often can result in brittle and inaccurate controllers, which, for example, have to be manually tuned for deployment. This adds to costs and can increase the time involved for robot deployment.

Reinforcement learning (RL) techniques have been demonstrated to be capable of learning continuous robot controllers involving interactions with the physical environment. However, a disadvantage commonly encountered in RL techniques, particularly those involving deep RL techniques with very expressive function approximators, may be the burdensome and time-consuming exploratory behavior, and the substantial sample inefficiency that may be involved, such as is generally the case when learning a control policy from scratch.

For an example of control techniques that may decompose the overall control strategy into a control part that is solved by conventional control techniques, and a residual control part, which is solved with RL, see the following technical papers, respectively titled: “Residual Reinforcement Learning for Robot Control” by T. Johannink; S. Bahl; A. Nair; J. Luo; A. Kumar; M. Loskyll; J. Aparicio Ojea; E. Solowjow; and S. Levine, published in arXiv:1812.03201v2 [cs.RO], 18 Dec. 2018; and “Residual Policy Learning” by T. Silver; K. Allen; J. Tenenbaum; and L. Kaelbling, published in arXiv: 1812.06298v2 [cs.RO], 3 Jan. 2019.

It will be appreciated that the approach described in the above-cited papers may be somewhat limited for broad and cost-effective industrial applicability since, for example, reinforcement learning from scratch tends to remain substantially data-inefficient and/or intractable.

### BRIEF DESCRIPTION OF THE DRAWINGS

FIG. 1 illustrates a block diagram of one non-limiting embodiment of a disclosed robotics control system, as may be used for control of a robotics system, as may involve one or more robots that, for example, may be used in industrial applications involving autonomous control.

FIG. 2 illustrates a block diagram of one non-limiting embodiment of a disclosed machine learning framework, as may be used for efficiently training a disclosed robotics control system.

FIG. 3 illustrates a flow chart of one non-limiting embodiment of a disclosed methodology for training a disclosed robotics control system.

FIGS. 4-7 respectively illustrate further non-limiting details in connection with the disclosed methodology for training a disclosed robotics control system.

### DETAILED DESCRIPTION

The present inventors have recognized that while the basic idea of combining Reinforcement Learning (RL) with conventional control seems very promising, prior to the various innovative concepts disclosed in the present disclosure, a practical implementation in an industrial setting has remained elusive since various nontrivial, technical implementation challenges have not been fully resolved in typical prior art implementations. Some of the challenges solved by disclosed embodiments are listed below:
appropriately synchronizing the two control techniques so that they do not counteract each other,
a proper choice and adjustment of the classic control law that is involved,
a systematic incorporation of simulated experience and real-world experience to train the control strategy in a simulator to, for example, reduce the required sample size.

At least in view of the foregoing considerations, disclosed embodiments realize appropriate improvements in connection with certain known approaches involving RL (see, for example, the two technical papers cited above). It is believed that disclosed embodiments will enable practical and cost-effective industrial deployment of RL integrated with conventional control. The disclosed control approach may be referred throughout this disclosure as Industrial Residual Reinforcement Learning (IRRL).

The present inventors propose various innovative technical features to substantially improve at least certain known approaches involving RL. The following two disclosed non-limiting concepts, indicated as concept I) and concept II), underlie IRRL:

Concept I)

In a conventional Residual RL technique, a hand-designed controller may involve a rigid control strategy, and, consequently, may not be able to easily adapt to a dynamically changing environment, which, as would be appreciated by one skilled in the art, is a substantial drawback to effectively operate in such an environment. For example, in an object insertion application that may involve randomly positioned objects, the conventional controller may be a position controller. The residual RL control part, may then augment the controller for overall performance improvement. If the position controller, for example, performs a given insertion too fast (e.g., the insertion velocity is too high), the residual RL part may not be able to timely assert any meaningful influence. For example, may not be able to dynamically change the position controller. Instead, in a practical application, the residual control part should be able to appropriately influence (e.g., beneficially oppose) the control signal generated by the conventional controller. For example, if the velocity developed by the position controller is too high, then the residual RL part should be able to influence the control signal generated by the conventional controller to reduce such high velocity. To solve this fundamental problem, the present inventors propose an adaptive interaction between the respective control signals generated by the classic controller and the RL. In principle, on the one hand, the initial conventional controller should be a guiding part and not an opponent to the RL part, and, on the other hand, the RL part should be able to appropriately adapt the conventional controller.

The disclosed adaptive interaction may be as outlined below. First, the respective control signals from the two control strategies (i.e., the conventional control and the RL control) may be compared in terms of their orthogonality, such as by computing their inner product. Signal contributions toward a same projected control “direction” may be punished in a reward function. This avoids that the two control parts “fight” each other. At the same time, a disclosed algorithm can monitor whether the residual RL part has components that try to fight the conventional controller, which may be an indication of inadequacies of the conventional controller for performing a given control task. This indication may then be used to modify the conventional control law, which can either be implemented automatically or through manual adjustments.

Second, instead of constant weighting, as commonly done in a conventional residual RL control strategy, the present inventors innovatively propose adjustable weights. Without limitation, the weight adjustment may be controlled by respective contributions of the control signals towards fulfilling the reward function. The weights become functions of the rewards. This should enable a very efficient learning and smooth execution. The RL control part may be guided depending on how well it has already learned. The rationale behind this is that as soon as the RL control part is at least on par with the initial hand-designed controller, the hand-designed controller is in principle not required anymore and can be partially turned off. However, the initial hand-designed controller will still be able to contribute a control signal whenever the RL control part delivers an inferior performance for a given control task. This blending is gracefully accommodated by the adjustable weights. An analogous, simplified concept would be “bicycle support training wheels”, which may be essential during learning, but can provide support even after the learning is finished, at least during challenging situations, e.g., riding too fast when taking a sharp turn.

Concept II)

Known approaches for training Residual RL in simulation generally suffer from hit-or-miss drawbacks, mainly because the simulation is generally setup a-priori. Typically, the control policy may be solely trained in a simulation environment and only afterwards the control policy is deployed in a real-world environment. Accordingly, the actual performance based on a control policy solely trained in the simulation environment, would not be self-evident till deployed in the real-world.

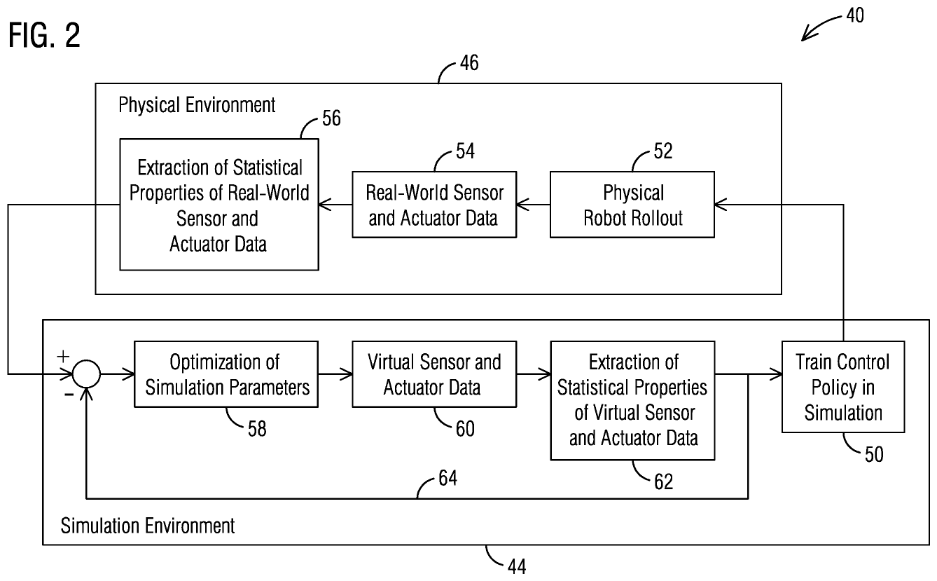

Accordingly, the present inventors further propose an iterative approach, as seen in FIG. 2, for training the IRRL control policy using virtual sensor and actuator data interleaved with real-world sensor and actuator data. Without limitation, a feedback loop may be used to adjust simulated sensor and actuator statistical properties based on real-world sensor and actuator statistical properties, such as may be obtained from a robot roll-out. It can be shown that appropriate understanding of the statistical properties (e.g., random errors, noise, etc.) of sensors and actuators in connection with a given robotic system may be decisive for appropriately fulfilling the performance of a control policy trained in simulation, when such a control policy is deployed in a real-world implementation.

Additionally, in the iterative approach proposed in disclosed embodiments, the simulation environment may be continuously adjusted based on real-world experience. In known approaches, as noted above, training in simulation is generally run until the simulated training is finished and then the simulated training is transferred to a physical robot in a robot roll-out. Instead, disclosed embodiments effectively interleave simulated experience and real-world experience to, for example, ensure that the simulated experience iteratively improves—in a time-efficient manner—quality and sufficiently converges towards the real-world experience. For example, a friction coefficient used in the simulation may be adjusted based on real-world measurements rendering virtual experiments more useful because the virtual experiments would become closer to mimicking the physics involved in a real-world task being performed by the robot, such as automated object insertions by the robot.

It is noted that in a practical application, simulation adjustments need not necessarily be configured for making a given simulation more realistic, but rather may be configured for achieving accelerated (time-efficient) learning. Accordingly, the physical parameters involved in a given simulation do not necessarily have to precisely converge towards the real-world parameters so long as the learning objectives may be achieved in a time-efficient manner.

The disclosed approach is an appropriately balanced way to rapidly close a simulation-to-reality gap in RL. Moreover, the disclosed approach can allow for making educated improvements to physical effects in the simulation and to quantify them in terms of their relevance for the control policy performance/improvement. For example, “How relevant is it to simulate in a given application electromagnetic forces that can develop between two objects?”. The point being that one would not want to allocate valuable simulation resources in connection with non-relevant parameters.

It will be appreciated that bringing simulation and real-world closer together may allow to appropriately tailor the sensor modalities involved in a given application. Without limitation, the disclosed approach can make evaluations about the physical environment. For example, evaluations about how accurate and/or sensitive a given sensor and/or actuator needs to be for appropriately fulfilling a desired control policy objective; or, for example, whether additional sensors and/or actuators need to be added (or whether different sensor modalities and/or actuator modalities need to be used). Without limitation, for example, the disclosed approach could additionally recommend respective locations of where to install such additional sensors and/or actuators.

In the following detailed description, various specific details are set forth in order to provide a thorough understanding of such embodiments. However, those skilled in the art will understand that disclosed embodiments may be practiced without these specific details that the aspects of the present invention are not limited to the disclosed embodiments, and that aspects of the present invention may be practiced in a variety of alternative embodiments. In other instances, methods, procedures, and components, which would be well-understood by one skilled in the art have not been described in detail to avoid unnecessary and burdensome explanation.

Furthermore, various operations may be described as multiple discrete steps performed in a manner that is helpful for understanding embodiments of the present invention. However, the order of description should not be construed as to imply that these operations need be performed in the order they are presented, nor that they are even order dependent, unless otherwise indicated. Moreover, repeated usage of the phrase “in one embodiment” does not necessarily refer to the same embodiment, although it may. It is noted that disclosed embodiments need not be construed as mutually exclusive embodiments, since aspects of such disclosed embodiments may be appropriately combined by one skilled in the art depending on the needs of a given application.

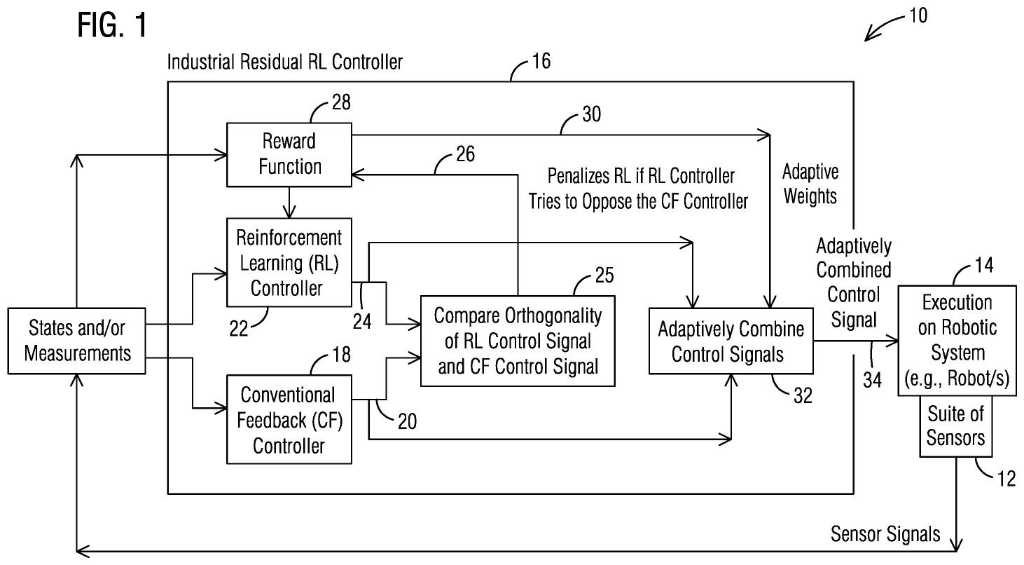

FIG. 1 illustrates a block diagram of one non-limiting embodiment of a disclosed robotics control system 10. A suite of sensors 12 may be operatively coupled to a robotic system 14 (e.g., robot/s) controlled by robotics control system 10. A controller 16 is responsive to signals from the suite of sensors 12.

Without limitation, controller 16 may include a conventional feedback controller 18 configured to generate a conventional feedback control signal 20, and a reinforcement learning controller 22 configured to generate a reinforcement learning control signal 24.

A comparator 25 may be configured to compare orthogonality of conventional feedback control signal 20 and reinforcement learning control signal 24. Comparator 25 may be configured to supply a signal 26 indicative of orthogonality relations between conventional feedback control signal 20 and the reinforcement learning control signal 24.

Reinforcement learning controller 22 may include a reward function 28 responsive to the signal 26 indicative of the orthogonality relations between conventional feedback control signal 20 and reinforcement learning control signal 24. In one non-limiting embodiment, the orthogonality relations between conventional feedback control signal 20 and reinforcement learning control signal 24 may be determined based on an inner product of conventional feedback control signal 20 and reinforcement learning control signal 24.

In one non-limiting embodiment, orthogonality relations indicative of interdependency of conventional feedback controller signal 20 and reinforcement learning controller signal 24 are penalized by reward function 28 so that control conflicts between conventional feedback controller 18 and reinforcement learning controller 22 are avoided.

In one non-limiting embodiment, reward function 28 of reinforcement learning controller 22 may be configured to generate a stream of adaptive weights 30 based on respective contributions of conventional feedback control signal 20 and of reinforcement learning control signal 24 towards fulfilling reward function 28.

In one non-limiting embodiment, a signal combiner 32 may be configured to adaptively combine conventional feedback control signal 20 and reinforcement learning control signal 24 based on the stream of adaptive weights 30 generated by reward function 28. Without limitation, signal combiner 32 may be configured to supply an adaptively combined control signal 34 of conventional feedback control signal 20 and reinforcement learning control signal 24. The adaptively combined control signal 34 may be configured to control robot 14, as the robot performs a sequence of tasks.

Controller 16 may be configured to perform a blended control policy for conventional feedback controller 18 and reinforcement learning controller 22 to control robot 14 as the robot performs the sequence of tasks. Without limitation, the blended control policy may include robotic control modes, such as including trajectory control and interactive control of robot 14. By way of example, the interactive control of the robot may include interactions, such as may involve frictional, contact and impact interactions, that, for example, may be experienced by joints (e.g., grippers) of the robot while performing a respective task of the sequence of tasks.

FIG. 2 illustrates a block diagram of one non-limiting embodiment of a flow of acts that may be part of a disclosed machine learning framework 40, as may be implemented for training disclosed robotics control system 10 (FIG. 1). In one non-limiting embodiment, the blended control policy for conventional feedback controller 18 and reinforcement learning controller 22 may be learned in machine learning framework 40, where virtual sensor and actuator data 60 acquired in a simulation environment 44, and real-world sensor and actuator data 54 acquired in a physical environment 46 may be iteratively interleaved with one another (as elaborated in greater detail below) to efficiently and reliably learn the blended control policy for conventional feedback controller 18 and reinforcement learning controller 22 in a reduced cycle time compared to prior art approaches.

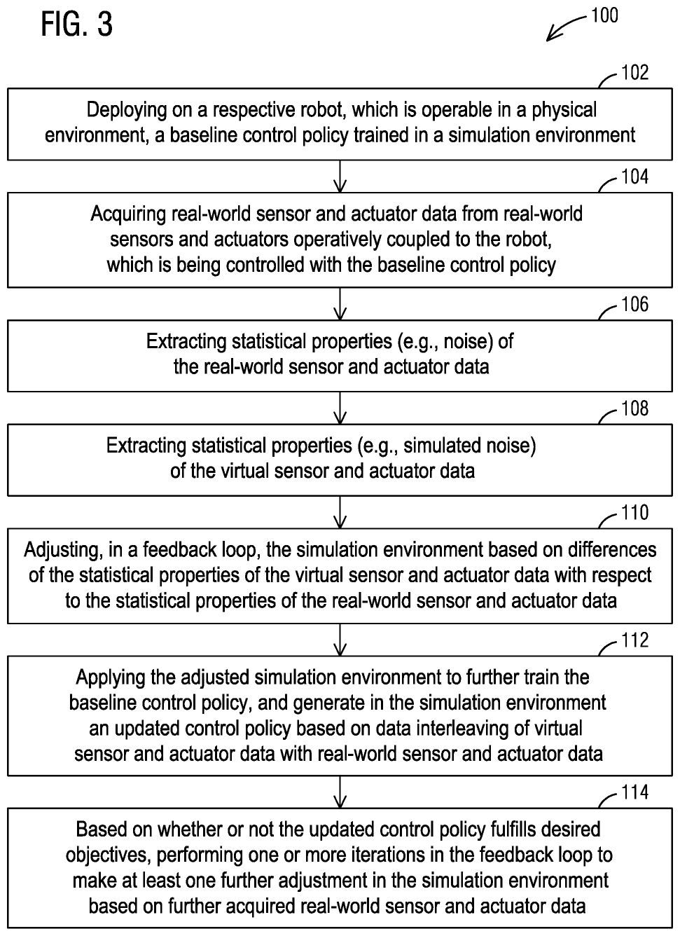

FIG. 3 illustrates a flow chart 100 of one non-limiting embodiment of a disclosed methodology for training disclosed robotics control system 10 (FIG. 1). Block 102 allows deploying—on a respective robot 14 (FIG. 1), such as may be operable in physical environment 46 (FIG. 2) during a physical robot rollout (block 52, (FIG. 2))—a baseline control policy for robotics control system 10. The baseline control policy may be trained (block 50, (FIG. 2)) in simulation environment 44.

Block 104 allows acquiring real-world sensor and actuator data (block 54, (FIG. 2) from real-world sensors and actuators operatively coupled to the respective robot, which is being controlled in physical environment 46 with the baseline control policy trained in simulation environment 44.

Block 106 allows extracting statistical properties of the acquired real-world sensor and actuator data. See also block 56 in FIG. 2. One non-limiting example may be noise, such as may be indicative of a random error of a measured physical parameter.

Block 108 allows extracting statistical properties of the virtual sensor and actuator data in the simulation environment. See also block 62 in FIG. 2. One non-limiting example may be simulated noise, such as may be indicative of a random error of a simulated physical parameter.

Block 110 allows adjusting—e.g., in a feedback loop 64 (FIG. 2) simulation environment 44—based on differences of the statistical properties of the virtual sensor and actuator data with respect to the statistical properties of the real-world sensor and actuator data.

Block 112 allows applying the adjusted simulation environment to further train the baseline control policy. This would be a first iteration that may be performed in block 50 in FIG. 2. This allows generating in simulation environment 44 an updated control policy based on data interleaving of virtual sensor and actuator data 60 with real-world sensor and actuator data 54.

As indicated in block 114, based on whether or not the updated control policy fulfills desired objectives, further iterations may be performed in feedback loop 64 (FIG. 2) to make further adjustments in simulation environment 44, based on further real-world sensor and actuator data 54 further acquired in physical environment 46.

The description below will proceed to describe further non-limiting aspects that may be performed in connection with the disclosed methodology for training disclosed robotics control system 10.

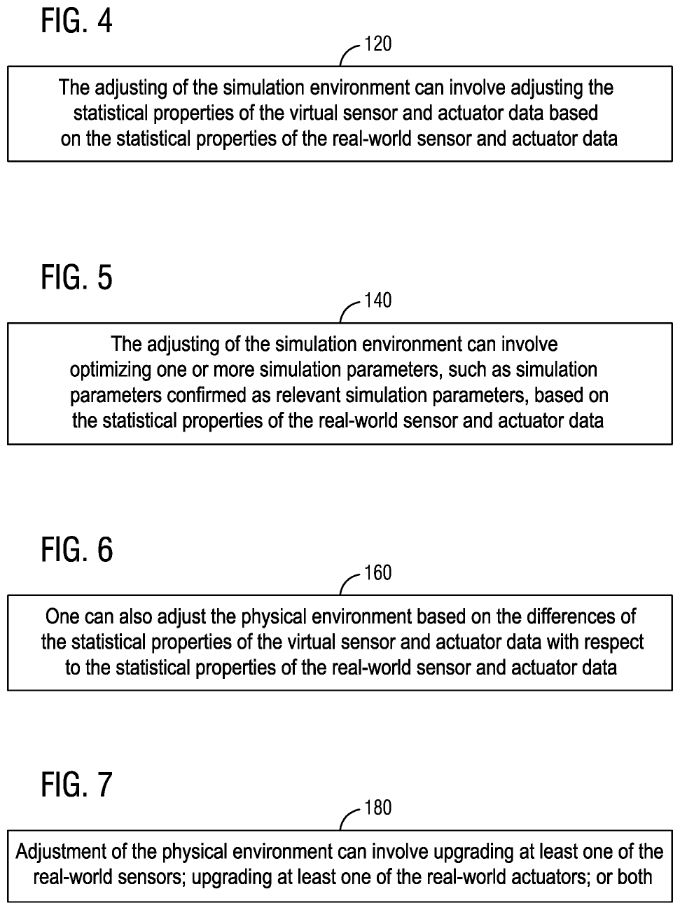

As illustrated in block 120 in FIG. 4, in one non-limiting embodiment, the adjusting of simulation environment 44 (FIG. 2) can involve adjusting the statistical properties of the virtual sensor and actuator data based on the statistical properties of the real-world sensor and actuator data.

As illustrated in block 140 in FIG. 5, in one non-limiting embodiment, the adjusting of simulation environment 44 (FIG. 2) can involve optimizing one or more simulation parameters, such as simulation parameters that may be confirmed as relevant simulation parameters, based on the statistical properties of the real-world sensor and actuator data. See also block 58 in FIG. 2.

As illustrated in block 160 in FIG. 6, in one non-limiting embodiment, one may adjust physical environment 46 (FIG. 2), based on the differences of the statistical properties of the virtual sensor and actuator data with respect to the statistical properties of the real-world sensor and actuator data. That is, in some situations the simulation may be adequate, but, for example, the real-world sensors and/or actuators used may be excessively noisy or otherwise inadequate to appropriately fulfill a desired control policy, such as inadequate resolution, not enough accuracy, etc.

For example, this may allow to appropriately tailor the real-world sensor and/or actuator modalities involved in a given application. Without limitation, the disclosed approach can make evaluations about how accurate and/or sensitive a given sensor and/or a given actuator needs to be for appropriately fulfilling a desired control policy objective; or, for example, whether additional sensors and/or additional sensors need to be added (or whether different sensor modalities and/or different actuator modalities need to be used). Without limitation, for example, the disclosed approach could additionally recommend respective locations of where to install such additional sensors and/or actuators.

As illustrated in block 180 in FIG. 7, in one non-limiting embodiment, adjustment of the physical environment can involve upgrading at least one of the real-world sensors; upgrading at least one of the real-world actuators; or both.

In operation, disclosed embodiments allow cost-effective and reliable deployment of deep learning algorithms, such as involving deep learning RL techniques for autonomous industrial automation that may involve robotics control. Without limitation, disclosed embodiments are effective for carrying out continuous, automated robotics control, such as may involve a blended control policy that may include trajectory control and interactive control of a given robot. By way of example, the interactive control of the robot may include relatively difficult to model interactions, such as may involve frictional, contact and impact interactions, that, for example, may be experienced by joints (e.g., grippers) of the robot while performing a respective task of the sequence of tasks.

Disclosed embodiments are believed to be conducive to widespread and flexible applicability of machine learned networks for industrial automation and control that may involve automated robotics control. For example, the efficacy of disclosed embodiments may be based on an adaptive interaction between the respective control signals generated by a classic controller and an RL controller. Additionally, disclosed embodiments can make use of a machine learned framework that effectively interleaves simulated experience and real-world experience to ensure that the simulated experience iteratively improves in quality and converges towards the real-world experience. Lastly, a systematic interleaving of simulated experience and real-world experience to train a control policy in a simulator is effective to substantially reduce the required sample size compared to prior art training approaches.

While embodiments of the present disclosure have been disclosed in exemplary forms, it will be apparent to those skilled in the art that many modifications, additions, and deletions can be made therein without departing from the scope of the invention and its equivalents, as set forth in the following claims.

What is claimed is:

1. A robotics control system 10 comprising:
a suite of sensors 12 operatively coupled to a robot controlled by the robotics control system; and
a controller 16 responsive to signals from the suite of sensors, the controller comprising:
a conventional feedback controller 18 configured to generate a conventional feedback control signal 20;
a reinforcement learning controller 22 configured to generate a reinforcement learning control signal 24;
a comparator 25 configured to compare orthogonality of the conventional feedback control signal and the reinforcement learning control signal, wherein the comparator is configured to supply a signal 26 indicative of orthogonality relations between the conventional feedback control signal and the reinforcement learning control signal;
wherein the reinforcement learning controller includes a reward function 28 responsive to the signal indicative of the orthogonality relations between the conventional feedback control signal and the reinforcement learning control signal, wherein orthogonality relations indicative of interdependency of the conventional feedback controller signal and the reinforcement learning controller signal are penalized by the reward function so that control conflicts between the conventional feedback controller and the reinforcement learning controller are avoided,
the reward function of the reinforcement learning controller configured to generate a stream of adaptive weights 30 based on respective contributions of the conventional feedback control signal and of the reinforcement learning control signal towards fulfilling the reward function; and
a signal combiner 32 configured to adaptively combine the conventional feedback control signal and the reinforcement learning control signal based on the stream of adaptive weights generated by the reward function of the reinforcement learning controller,
wherein the signal combiner is configured to supply an adaptively combined control signal 34 of the conventional feedback control signal and the reinforcement learning control signal, the adaptively combined control signal configured to control the robot as the robot performs a sequence of tasks.

2. The robotics control system of claim 1, wherein the orthogonality relations between the conventional feedback control signal and the reinforcement learning control signal are determined based on an inner product of the conventional feedback control signal and the reinforcement learning control signal.

3. The robotics control system of claim 1, wherein the controller is configured to perform a blended control policy for the conventional feedback controller and the reinforcement learning controller to control the robot as the robot performs the sequence of tasks.

4. The robotics control system of claim 3, wherein the blended control policy comprises robotic control modes including trajectory control and interactive control of the robot.

5. The robotics control system of claim 4, wherein the interactive control of the robot comprises frictional, contact and impact interactions by joints of the robot while performing a respective task of the sequence of tasks.

6. The robotics control system of claim 3, wherein the blended control policy for the conventional feedback controller and the reinforcement learning controller being learned in a machine learning framework, wherein virtual sensor and actuator data acquired in a simulation environment, and sensor and actuator data acquired in a physical environment are iteratively interleaved with one another to learn the blended control policy for the conventional feedback controller and the reinforcement learning controller in a reduced cycle time.

7. A method for training a robotics control system, the method comprising:
deploying 102 on a respective robot 14, which is operable in a physical environment 46, a baseline control policy for the robotics control system, the baseline control policy trained in a simulation environment 44;
acquiring 104 real-world sensor and actuator data 54 from real-world sensors and actuators operatively coupled to the respective robot, which is being controlled in the physical environment with the baseline control policy;
extracting 106 statistical properties of the acquired real-world sensor and actuator data;
extracting 108 statistical properties of virtual sensor and actuator data in the simulation environment;
adjusting 110, in a feedback loop, the simulation environment based on differences of the statistical properties of the virtual sensor and actuator data with respect to the statistical properties of the real-world sensor and actuator data;
applying 112 the adjusted simulation environment to further train the baseline control policy, and generate in the simulation environment an updated control policy based on data interleaving of virtual sensor and actuator data with real-world sensor and actuator data;
based on whether or not the updated control policy fulfills desired objectives, performing 114 further iterations in the feedback loop to make further adjustments in the simulation environment based on further real-world sensor and actuator data acquired in the physical environment.

8. The method for training the robotics control system of claim 7,
wherein the robotics control system comprises a conventional feedback controller 18 and a reinforcement learning controller 22,
wherein the data interleaving is configured to reduce a training sample size to fulfill a blended control policy for the conventional feedback controller and the reinforcement learning controller.

9. The method for training the robotics control system of claim 7, wherein the adjusting of the simulation environment comprises adjusting 120 the statistical properties of the virtual sensor and actuator data based on the statistical properties of the real-world sensor and actuator data.

10. The method for training the robotics control system of claim 7, wherein the adjusting of the simulation environment comprises optimizing 140 one or more simulation parameters based on the statistical properties of the real-world sensor and actuator data.

11. The method for training the robotics control system of claim 7, wherein, based on the differences of the statistical properties of the virtual sensor and actuator data with respect to the statistical properties of the real-world sensor and actuator data, confirming relevancy of simulation parameters towards fulfilment of the control policy for the robotics control system in the simulation environment.

12. The method for training the robotics control system of claim 7, wherein, based on the differences of the statistical properties of the virtual sensor and actuator data with respect to the statistical properties of the real-world sensor and actuator data, confirming relevancy measurements by the sensors and actuators operatively coupled to the respective robot in the physical environment towards fulfilment of the control policy for the robotics control system in the simulation environment.

13. The method for training the robotics control system of claim 7, wherein, based on the differences of the statistical properties of the virtual sensor and actuator data with respect to the statistical properties of the real-world sensor and actuator data, adjusting 160 the physical environment.

14. The method for training the robotics control system of claim 13, wherein the adjusting of the physical environment comprises: upgrading at least one of the real-world sensors, upgrading at least one of the real-world actuators, or both.

15. The method for training the robotics control system of claim 13, wherein, the adjusting of the physical environment comprises adding at least one further sensor, adding at least one further actuator, or both.

16. The method for training the robotics control system of claim 13, wherein, the adjusting of the physical environment comprises changing a sensing modality of one or more of the sensors, changing an actuating modality of one or more of the actuators, or both.
